(19) United States
(12) Patent Application Publication
(10) Pub. No.: US 2025/0111843 A1
(43) Pub. Date: Apr. 3, 2025

(54) SYSTEMS AND METHODS FOR MODELING AN AUDIO SYSTEM

(71) Applicant: Georgios Gkountouras, Helsinki (FI)

(72) Inventor: Georgios Gkountouras, Helsinki (FI)

(21) Appl. No.: 18/904,826

(22) Filed: Oct. 2, 2024

Related U.S. Application Data
(60) Provisional application No. 63/542,063, filed on Oct. 2, 2023.

(51) Int. Cl. G10K 11/178; G10H 3/18

(52) U.S. Cl. CPC G10K 11/17823; G10H 3/187

(57) ABSTRACT

A closed loop system with trainable parameters and known dynamics is trained to model a reference audio system. Solving the closed loop equations in continuous time can involve an implicit solver. Training may be carried out by repeating a set of operations. The set of operations may include computing in the time domain (via the closed loop system) a model output, based upon an input. The output is expected to approximate the output of the reference audio system. The set of operations may further include applying a loss function, where the loss function measures the difference between the output of the closed loop system and the output of the reference audio system. The set of operations also includes adjusting the trainable parameters according to the output of the loss function. The training produces an output model that can be used to filter input signals.

### CROSS-REFERENCE TO RELATED APPLICATIONS

The present application claims the benefit of U.S. Provisional Patent Application No. 63/542,063 filed Oct. 2, 2023, and entitled “System and Method to Create a Modeling Audio System,” which is incorporated by reference herein.

### FIELD OF THE INVENTION(S)

Embodiments of the present invention(s) related generally to systems and methods of modeling audio systems and more particularly to providing accurate audio reproduction.

### BACKGROUND

Audio effects are used for corrective and/or creative reasons in various media, such as music, films or video games. Audio processing often includes manipulating the dynamics, equalization, pitch, timbre, etc. of the sound of audio recordings. Modeling (i.e., creation of virtual models) of specific audio processors, such as a guitar amplifier, is an active field of research and commercial interest. In particular, analog circuits, sometimes combined with mechanical components, can result in a system with non-linear and time-varying response that is difficult to simulate digitally. Typically, this non-linear behavior is considered desirable by musicians. Traditional analyses (e.g., white-box methods) require expert knowledge, as well as time-consuming and expensive measurements of the reference audio systems.

On the other hand, black-box optimization methods, such as techniques employing neural networks to model audio processors, do not take full advantage of any potentially known information about the reference audio system being modeled. Thus, they are difficult to train, compose into larger systems, understand (in the context of their internals), evaluate, and so on. Furthermore, it is not trivial to incorporate user controls in such systems (e.g., as requested by a musician for live performance purposes).

### SUMMARY

An example non-transitory computer-readable medium comprises executable instructions. The executable instructions may be executable by one or more processors to perform a method. The method may comprise receiving an input signal from an audio system to be modeled to create a reference signal of the audio system, receiving trainable and system parameters, the system parameters characterizing unchanging aspects that define a sound of the audio system, the trainable parameters including measurements of at least one component of the audio system to be modeled, modeling, using a closed loop process, the audio system to create a model of the audio system (the modeling may comprise: simulating an output of the audio system to generate a simulation signal using a neural network configured with the trainable and system parameters, comparing the simulation signal to the reference signal, and adjusting weights of the trainable parameters of the neural network to compensate for a difference between the simulation signal and the reference signal), determining whether a stopping condition is satisfied, the stopping condition being based on the modeling, until the stopping condition is satisfied, modeling, using the closed loop process (the modeling may comprise simulating a new output of the audio system to generate a new simulation signal using the neural network including the previously adjusted weights, comparing the new simulation signal to the reference signal, and readjusting weights of the trainable parameters of the neural network to compensate for a difference between the new simulation signal and the reference signal), and outputting the model of the audio system, the model including changes to the trainable parameters derived from the neural network, the model being capable of receiving an input signal and outputting a modeled signal of the audio signal in real time.

The reference signal of the audio system may be generated by denoising the input signal from the audio system. In some embodiments, the closed loop process is in continuous time. Further, the closed loop process may not have sampling delays.

In various embodiments, the stopping condition is satisfied when a loss value generated by a loss function applied to the comparison of the new simulation signal to the reference signal is below a threshold value. In some embodiments, the stopping condition is satisfied when modeling occurs a particular number of times.

In some embodiments, at least one of the weights of the trainable parameters of the network networks adjusts at least a part of a spectral energy. The model may include at least one of a sample rate, channel count, or timing for controls.

In some examples of the audio system, the audio system may be a guitar amplifier or a voice.

In some embodiments, simulating the new output of the audio system comprises representing a plurality of the trainable parameters by a plurality of differential algebraic equations (DAEs) in the closed loop process and solving the plurality of differential algebraic equations together in continuous, not discrete, time. Solving the plurality of differential algebraic equations together may comprise approximating one or more solutions of the plurality of differential algebraic equations.

An example method may comprise receiving an input signal from an audio system to be modeled to create a reference signal of the audio system, receiving trainable and system parameters, the system parameters characterizing unchanging aspects that define a sound of the audio system, the trainable parameters including measurements of at least one component of the audio system to be modeled, modeling, using a closed loop process, the audio system to create a model of the audio system (the modeling may comprise: simulating an output of the audio system to generate a simulation signal using a neural network configured with the trainable and system parameters, comparing the simulation signal to the reference signal, and adjusting weights of the trainable parameters of the neural network to compensate for a difference between the simulation signal and the reference signal), determining whether a stopping condition is satisfied, the stopping condition being based on the modeling, until the stopping condition is satisfied, modeling, using the closed loop process (the modeling may comprise simulating a new output of the audio system to generate a new simulation signal using the neural network including the previously adjusted weights, comparing the new simulation signal to the reference signal, and readjusting weights of the trainable parameters of the neural network to compensate for a difference between the new simulation signal and the reference signal), and outputting the model of the audio system, the model including changes to the trainable parameters derived from the neural network, the model being capable of receiving an input signal and outputting a modeled signal of the audio signal in real time.

An example system may include at least one processor and memory containing executable instructions. The executable instructions may be executable by the at least one processor to receive an input signal from an audio system to be modeled to create a reference signal of the audio system, receive trainable and system parameters, the system parameters characterizing unchanging aspects that define a sound of the audio system, the trainable parameters including measurements of at least one component of the audio system to be modeled, model, using a closed loop process, the audio system to create a model of the audio system (the modeling comprising the at least one processor configured to: simulate an output of the audio system to generate a simulation signal using a neural network configured with the trainable and system parameters, compare the simulation signal to the reference signal, and adjust weights of the trainable parameters of the neural network to compensate for a difference between the simulation signal and the reference signal) determine whether a stopping condition is satisfied, the stopping condition being based on the modeling, until the stopping condition is satisfied, model, using the closed loop process (the modeling comprising the at least one processor configured to: simulate a new output of the audio system to generate a new simulation signal using the neural network including the previously adjusted weights, compare the new simulation signal to the reference signal, and readjust weights of the trainable parameters of the neural network to compensate for a difference between the new simulation signal and the reference signal), output the model of the audio system, the model including changes to the trainable parameters derived from the neural network, the model being capable of receiving an input signal and outputting a modeled signal of the audio signal in real time.

### BRIEF DESCRIPTION OF THE SEVERAL VIEWS OF THE DRAWINGS

FIG. 1 is a block diagram illustrating various components that can be used for building and/or using a modeling system with trainable parameters that models a reference audio system.

FIG. 2 depicts a process to create audio processing systems in some embodiments.

FIG. 3 depicts a circuit schematic representing an example reference audio system in some embodiments.

FIG. 4 depicts an illustration which shows an example formulation for the initial value problem (IVP) for a general system of differential algebraic equations (DAEs) in some embodiments.

FIG. 5 depicts an illustration that shows an instance of a nonlinear solve in some embodiments.

FIG. 6 depicts an illustration that shows a circle 602 as an instance of a definition through an implicit relation in some embodiments.

FIG. 7 depicts an illustration showing an example model of a closed loop system in some embodiments.

FIG. 8 depicts an illustration which shows an example model of a musical instrument in some embodiments.

FIG. 9 depicts an illustration that shows an example model that comprises a singing synthesizer in some embodiments.

FIG. 10 depicts an illustration that shows an example model of a closed loop system in some embodiments.

### DETAILED DESCRIPTION

For the reasons discussed herein, the need arises for a virtualization method that is general, powerful, composable, interpretable, easy to use, and controllable. Some embodiments describe aspects of such a modeling audio system that simulates real systems and combines aspects of both white-box and black-box methods. It can be implemented using hardware, software, or a combination thereof. In this manner, it defines a modeling platform that can create and use virtual models of several reference audio systems (e.g., physical amplifiers) in a flexible and efficient implementation.

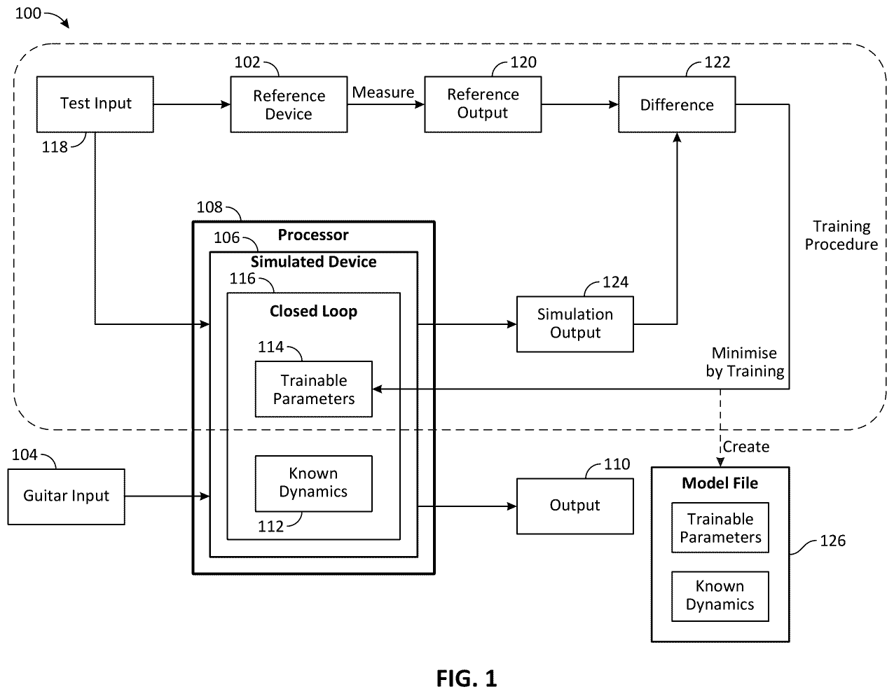

Referring now to the drawings, and in particular to FIG. 1, a block diagram 100 of a system using at least one trainable parameter to create a virtual model of an audio system. In some embodiments, the block diagram 100 illustrates various components that can be used for creating, altering, enhancing, and/or using the virtual model. For sake of clarity of this explanation, the particular embodiment of FIG. 1 is described in the context of virtualizing a reference audio system 102 that is implemented as a guitar amplifier. It will be appreciated, however, that the reference audio system 102 may be implemented in any audio system (e.g., not limited to an amplifier).

The reference audio system, or “reference device” 102 will be understood to mean the system being modeled. However, this is only meant to illustrate some aspects of the invention and should not be interpreted as limiting the claimed Subject matter to the specific examples. In particular, any references of a “real guitar amplifier” can be replaced, for instance, with “physical musical instrument,” “vocal tract,” or “room acoustics.”

The motivation for modeling becomes apparent, considering that it may not always be practical for the reference audio system 102 to be used. Various embodiments enable a virtual model of the reference audio system 102 to be used whenever the reference audio system 102 would be employed traditionally. As shown in FIG. 1, a user (e.g., musician) may plug an output of a musical instrument (e.g., electric guitar) 104 into a modeling audio system 106. The modeling audio system 106 may model at least some aspects of the reference audio system 102. The modeling audio system 106 is also referred to as “virtual model,” “virtualization,” “virtual device,” “simulated device,” or other variations of the same theme. In various embodiments, the modeling audio system 106 will consist of some combination of analog circuitry, digital circuitry and software (e.g., a standalone hardware unit, or a general purpose computer equipped with an audio interface). In one example, the input audio signal (e.g., guitar signal) 104 is processed through an analog to digital converter (ADC) that converts the analog signal into a digital signal equivalent. The digital signal is input into a simulated device 106 within a processor (e.g., CPU) 108. The simulated device 106 is, as will be described in greater detail herein, specifically trained, or otherwise configured, to match some or all characteristics of reference audio system 102. The output of modeling audio system 106 is processed by a digital to analog converter (DAC) that converts the digital output into an analog signal equivalent of the digital output. The analog output 110 can then be, for example, further processed by other devices, or coupled to a speaker to produce sound.

Aspects herein define modeling of a reference audio system 102 that is carried out using at least one trainable parameter. It will be appreciated that there may be a plurality of these trainable parameters (e.g., arranged in a neural network or another AI system). In some embodiments, a modeling audio system 106 utilizes one or more neural networks to achieve the desired results, however, it will be appreciated that other modeling approaches may be used (e.g., analytical, random forest, decision trees, and/or the like). In one example, the modeling audio system 106 may be deployed, after a training phase, in the form of two sets of parameters. The first set may be or include known system dynamics 112. A known system dynamic parameter may be or include those that were not trained to improve the modeling system. These can include, but are not limited to, the laws of physics. The second parameter set may be or include trainable parameters 114. Trainable parameters may be or include neural network models of components (such as transistors) of reference audio system 102, neural network models of interactions within subsystems of reference audio system 102, parameters trainable in a differentiable programming context, and/or the like. In some embodiments, the two sets of parameters can be deployed together (e.g., loaded from one or more “model” file(s) in persistent storage (e.g., disk) into computer memory (e.g., volatile RAM)). In addition, or alternatively, particular sets of trainable parameters can be mixed to create a new configuration, either to model a different reference audio system 102 (e.g., a different make/model of amplifier) or for other purposes (e.g., to create an original device).

In some embodiments, the processor 108 may process the input signal received in 118 to identify trainable parameters. In one example, the input is tested and analyzed to identify audio components that are trainable (e.g., spectral energy, component signals, and the like). The processor 108 may then utilize those audio components that are trainable as all or part of the trainable parameters in model creation as discussed herein. Different known dynamics 112 can also be employed in the same context.

More particularly, and in opposition to conventional wisdom within the application domain, known dynamics and trainable parameters comprise a closed loop system 116. Notably, this closed loop system 116 may be defined in continuous time and can include feedback paths without sample delays. Example equations that describe the closed loop system 116 are examined in herein.

The virtual model 106 may also include additional functionality external to the reference audio system 102. For example, the virtual model 106 may include a graphical user interface that enables its user to select emulations and/or simulations of different speakers, speaker cabinets, dynamics processing, equalization, effects processing, or the like that is not within the capabilities of reference audio system 102. Such processing may also include two or more processors in series, or in parallel, or in a feedback or cross-feed configuration, or any combination thereof.

In one example of a way to train a neural network is to record and use information from the reference audio system 102. In this example, a test input signal 118 (e.g., an exponential sine sweep (ESS), white noise, or an instrument performance) is coupled to the input of reference audio system 102. The output is recorded (e.g., via a microphone, oscilloscope, audio interface, or other measurement device) and stored as reference output 120 collected from the reference audio system 102.

Although the reference output 120 labeled in the illustration is nominally the output of the device, in principle any measurement of the reference audio system 102 can also be considered an output. For instance, the measurement of an internal voltage of a real guitar amplifier that functions as the reference audio system 102 can be utilized in this manner, corresponding to the same internal voltage in the modeling audio system 106. Similarly, test input signal 118 may include one or more electrical signals applied directly at internal points of the reference audio system 102 (e.g., via controlled voltage sources).

The recorded reference output 120 of reference audio system 102, alongside, in some embodiments, the stored test input signal 118 may be used as training data to train one or more neural networks 114 in order to model reference audio system 102. In some embodiments, additional information such as audio attributes (e.g., energy, spectral measurements such as spectral intensities or spectral distribution, and so on) can be calculated from the existing reference output 120 and function as additional or alternative training data in the form of features. In one example, audio attributes may be spectral energy that may be represented as one or more spectral intensity values and/or spectral distribution.

In some embodiments, other data can be used to train the trainable parameters 114 by functioning as additional or alternative training data to the reference output 120 and any features derived from it. Although not strictly required, this data is typically representative in some sense (e.g., statistical) of the inputs 104 that the modeling audio system 106 is expected to encounter during its regular operation. For instance, a model 106 of a guitar amplifier can be trained using guitar audio tracks in the form of recorded samples as test input signal 118. In another embodiment, data from simulations can augment or replace test input signal 118, due to ease of availability, low costs, etc.

By way of example, consider the case where those parameters are arranged in a neural network (e.g., a fully-connected neural network). The neural network is composed of neurons (mathematical functions) that may include, for example, weights and biases as trainable parameters 114 in addition to fixed activation functions. Each neuron, in this example, may have more than one input, depending on the dimensionality of the previous layer in the neural network. In this example, there are two phases. During the first phase, known as the training phase, the weights and biases of the neural network may be adjusted to tune the network. The goal of this training procedure is to derive a new set of values for the trainable parameters 114 such that the modeling audio system 106 matches at least some characteristics of the reference audio system 102. We may then further say that the model within the modeling audio system 106 is trained when it converges to a state that is accepted, so that modeling audio system 106 is indicative of the reference audio system 102. During the second phase, known as the inference or deployment phase, with the set of trainable parameters 114 now considered trained and therefore fixed, the simulation model (e.g., virtualization) can be employed for use so as to produce an output matching the behavior of reference audio system 102.

Training the trainable parameters 114 may include computing a difference 122 between the measured output 120 of the reference audio system 102 and the simulation output 124 of the modeling audio system 106. In some contexts, this difference can be referred to as a loss function. After the trainable parameters 114 have been trained, a process can store, archive, access, save, load, and the like, a model file 126 of parameters created as part of the training process. For convenience of transfer, distribution, and the like, the model file 126 may also include the known system dynamics 112 that are associated with the model. The model file 126 may also include metadata (e.g., model description and structure, version information, parameter ranges, or the like) or additional audio-related features (e.g., sample rate, channel count, update timing for controls, or the like). In any case, the model file 126 includes sufficient information so that it can be loaded and run on processor 108 to instantiate a functioning model (e.g., virtualization) of the reference audio system 102.

A virtualization, for example, is the system that is used instead of the reference audio system 102. The virtualization in this example includes both trainable parameters 114 and known system dynamics 112 in the arrangement of a closed loop system 116. The model file 126 containing these parameters may be created by the modeling audio system 106 itself, or downloaded from the cloud, or read from removable storage (e.g., disk drive), and so on. In the latter cases, the model file 126 may be created, adapted, and/or the like on a different device (e.g., computer) than the modeling audio system 106. In some embodiments, the virtualization may re-create the simulated device from trainable parameters 114 and known system dynamics 112 loaded from a model file 126 for each separate reference audio system 102 to be modeled. More generally, the virtualization and corresponding model file 126 may include a wider framework for solving closed loop system 116 (e.g., a solver and the corresponding parameters of that solver), as discussed herein.

The modeling audio system 106 can also include other capabilities. For example, the modeling audio system 106 can include metadata, executable code for additional audio processing (virtual effects), user controls, automation functionality, and so on. This makes the modeling audio system 106 more usable for the end user (e.g., musician).

In some embodiments, the modeling audio system 106 includes the circuitry (e.g., ADC, DAC, other), the virtual model, optional additional processing (e.g., audio processing different than the virtual model), and the like. The modeling audio system 106 (e.g., dedicated hardware or computer and audio interface) may optionally include a graphical user interface (GUI), physical controls (e.g., buttons, knobs, sliders, or the like), virtual controls, or the like to facilitate usage for the end user (musician).

The trainable parameters 114, usually but not exclusively in the form of a neural network, may be a part of the modeling audio system 106 and is capable of real-time operation, (e.g., in a performance context). As a result, the modeling audio system 106, may process audio in the time domain (the input and output of the system are time domain audio signals).

An example of a training procedure is outlined in FIG. 1. However, note that typically all system dynamics (both trainable parameters 114 and known system dynamics 112) are involved in the training procedure in an end-to-end fashion. This enables the correct evaluation of the modeling audio system 106 and measurement of its output 124.

In some embodiments, training the trainable parameters 114 can occur within the modeling audio system 106 itself. For instance, the modeling audio system 106 may include means (e.g., a signal generator or audio playback capabilities) to create test input 118, means (e.g., microphone, analog or digital audio input) to measure the reference output 120, other capabilities to aid this process (e.g., ability to act as reactive load), as well as any processing and the like necessary to implement the parameter training process described herein. Moreover, the modeling audio system 106 can include memory or persistent storage to store one or more model files 126 so that the modeling audio system 106 can load alternative virtualizations that correspond to different reference audio systems 102, or combinations thereof (e.g., a guitar amplifier model coupled with a room acoustics model).

The processor 108 may be any kind of computing device that can execute instructions of a computer program. For instance, processor 108 may be or include one or more CPUs, GPUs, MCUs, DSPs, TPUs, NPUs, MPUs, APUs, DPUs, FPGAs, FPAAs, ASICs, quantum computers, analog computers (e.g., implemented with electrical circuits), optical computers, and/or the like (in any combination). The processor 108 may also include a combination of one or more of these devices, with possible communication among them. Part or all of the operations of one or more of these processors 108 may also be included in a white-box part of the embodiment as known system dynamics 112. For instance, an analog computation implemented with electrical circuits can be run on a different processor, such as a CPU. Furthermore, any Digital Signal Processing (e.g., discrete-time convolution) may be included in the known system dynamics 112.

In addition, the processor 108 can be part of a cloud deployment, existing in a server rather than locally (or both where some processing is performed locally while other processing is performed remotely). In some embodiments, at least some of these deployments are capable of real-time operation, in order to enable user workflows. Another option is running on the user's device via the web (e.g., via WASM). In various embodiments, the processor 108 may be embedded in another device, such as a mobile phone. The processor 108 can communicate (e.g., via bus) with memory and other components typically present in general or special purpose computers. The processor 108 can load data and instructions from memory,

The memory can store information accessible via the processor 108, including instructions of a computer program that may be executed by the processor 108. Memory also includes data that may be retrieved, altered and stored by the processor 108. Similarly, the memory may be directly read or written via peripherals (e.g., sensors or input devices), for instance through the use of DMA. The memory may be of any type capable of storing information accessible via the processor, for instance hard drive, solid state drive, flash memory, memory card, CD-ROM, DVD, EPROM, EEPROM, DRAM, SRAM, HBM, VRAM, CPU cache, magnetic tape drive, punched card, and so on.

The program may be in the form of instructions to be executed by the processor 108. For instance, these instructions can consist of machine code. In another example, the instructions may inform the configuration of an FPGA, or the operations to be performed in a quantum computer. The instructions may be in object code format, source code format, combinations thereof and so on. The instructions may be compiled in advance, interpreted as required, JIT-compiled for performance reasons, combinations thereof, and so on. Data may be read, modified or written by the processor 108, according to the instructions of a computer program. The data may be stored as a table in a relational database.

Alternatively, the data can be stored in structured form in computer files (e.g., a JSON file or an XML file). The data may also be formatted in any format fit to be read by a computer including, but not limited to, binary, ASCII, or Unicode. In addition, the data may also comprise metadata, such as descriptions in plain text, pointers or references to the same or other pieces of data, information about parameters, and/or the like.

An example of such data is the model file 126, which stores sufficient information to reconstruct the virtualization. Another instance of data would be stored interpolation tables that can aid in computing the result of numerical functions. Yet another example would be stored procedures, either in source form, or as opcodes, or in compiled form, or in a combination thereof. In yet another example, the data may include known information about the measurement setup, such as microphone positions, electrical probe impedances, and so on.

The instructions can include, for instance, automated measuring of the reference audio system 102 to be modeled, training the trainable parameters in accordance with process 200, creating a model file 126 that features both trained parameters and known dynamics, and processing input 104 using the loaded virtualization.

The combination of one or more processors and one or more memories, alongside any related peripherals may or may not reside in the same physical enclosure. For instance, part of the instructions and data may be stored in removable media, such as a memory card. In another example, part or all of the instructions or data may reside in a different location from the processor, yet still be able to be accessed by the processor, e.g., through a computer network. The processor may be physically realized as a combination of processors that operate in parallel.

The description of processor 108 herein, alongside the descriptions of any associated memory, buses, etc., is only meant to be demonstrative of the subject matter and its implementations. This description does not restrict the invention to any specific embodiment provided herein. Practical embodiments of the invention described in this specification can be implemented using digital electronic circuitry, or in software, firmware, or hardware. In particular, one or more devices described herein can be combined in one embodiment. The storage medium can be in the form of any computer-readable storage device (e.g., a hard disk or any non-transitory medium configured to store instructions for controlling a processor to perform any number of methods). Alternatively or in addition, it can be in the form of a random or serial access memory array. It will be understood by those of ordinary skill in the art, that various combinations or structural equivalents are possible in practical embodiments. For instance, in the case of a quantum computer, the program instructions can be logic gate operations that are coded as the artificial generation of timed electromagnetic pulses to be executed on the quantum computer.

The computing device can also include, in addition to hardware, code that creates an environment for the computer program, e.g., code that constitutes processor firmware, a protocol stack, a database management system, an operating system, a graphical user interface, a runtime environment (such as a virtual machine), and so on. The execution environment can realize many different computing topologies, e.g., cloud deployment, edge computing, embedded devices, etc. For instance, a separate embedded device that implements modeling audio system 106, can expose over a local network controls (e.g., a graphical user interface) so that it may be controlled by the user via a general purpose computer.

A computer program may be written in any programming language and it can be deployed in any form, including as a stand-alone executable, an extension module, a collection of one or more subroutines (i.e., functions), in object format, or in any other form that is suitable to be included in a computing environment. A computer program may correspond to a file in a file system, but that is not strictly necessary. For instance, a computer program may be spread over many files. In contrast, a single file may contain multiple computer programs. In practical embodiments, one common case is to have multiple interconnected (e.g., via include statements) files, e.g., files containing one or more modules, functions, extensions, specializations, scripts, pieces of code and so on.

Embodiments of the invention described herein can be implemented on mobile phones, smart phones, tablets, PDAs, personal computers and stand-alone processing hardware. These devices can be accompanied by digital displays in the same or in a separate enclosure, (e.g., CRT (cathode ray tube) or LCD (liquid crystal display) monitors) for the purpose of displaying information to the user. User input may be received by peripherals, e.g., a keyboard or a mouse (pointing device). Other types of user input are possible, including tactile input, voice commands, eye tracking, accelerometers, etc. Similarly, other types of output are possible to provide feedback to the user, such as visual feedback, auditory feedback, tactile feedback, and so on. A computer may also interact with the user by sending messages to (and receiving messages from) another device controlled by the user, (e.g., MIDI or OSC messages).

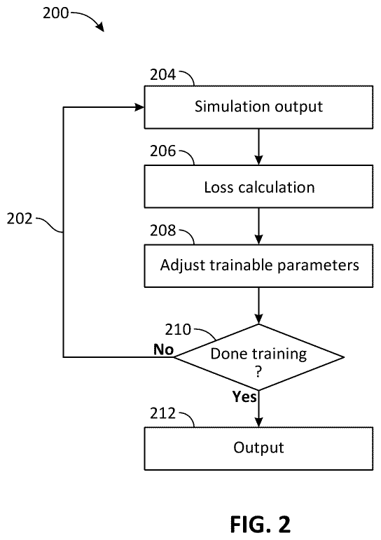

FIG. 2 depicts a process 200 to create audio processing systems in some embodiments. The process 200, which trains the trainable parameters 114, can be used, for example, to create the model file 126 (see FIG. 1). In various embodiments, the process 200 can be carried out by the modeling audio system 106, by a general purpose computer (e.g., user device), by dedicated hardware, and/or the like.

The process 200 comprises a training loop 202, in which the trainable parameters may be changed to create a virtual model of a reference audio system. In some embodiments, the training can stop at a predetermined stopping condition. For instance, training can stop when a particular desired loss (e.g., a difference between modeling audio system and reference audio system, measured with some predetermined error measure) amount has been reached. In that example, the trainable parameters (e.g., one or more neural networks) are said to have converged to the desired model state. Another example stopping condition can be time (e.g., 10 minutes), measured in either wall clock time or processor CPU cycles. Another instance of a stopping condition can be when all available training data has been processed for a predetermined number of iterations (e.g., 10,000 iterations). Furthermore, the stopping condition can be changed to accommodate various trainable parameter compositions (e.g., neural network architectures), desired model goals (e.g., the user wants to be able to stop training manually), quality-performance tradeoffs, different loss functions, and the like.

The states, including any output states, of a reference audio system (e.g., real guitar amplifier) may depend (non-linearly in the general case) on the inputs to the reference audio system. Such inputs may include, for example, the nominal audio input of the system where the musician couples their instrument. Moreover, the inputs can include one or more controls (e.g., knobs on the real amplifier) that can be altered by the user, potentially in real-time. Although these controls are referred to as parameters in some contexts, they should not be confused with the trainable parameters. In any case, the inputs can be modeled, for instance, as forcing functions within the closed loop system.

Some examples of neural network architectures utilized as trainable parameters can be Convolutional Neural Networks (CNNs), Recurrent Neural Networks (RNNs), continuous-time echo state networks (CTESNs), WaveNets, and so on. However, other configurations of trainable parameters are also possible. For instance, parameters trainable in a differentiable programming context so as to model a reference analog or digital system can also be employed in that context.

In some embodiments, training of the trainable parameters is accomplished by finding values for the trainable parameters based on training data (e.g., audio measurements 120). For instance, training data can be created by inputting the test input (e.g., musical recording, exponential sine sweep, white noise, real-time input, and/or the like) into the reference audio system and measuring the output of the reference audio system that corresponds to the test input. This particular example is examined in greater detail with regard to FIG. 1.

Furthermore, a parametric sweep can change one or more inputs (for instance, control inputs) during the measurement process in order to capture a more representative and general behavior of the reference audio system. It will be appreciated that other combinations of test input signals are possible.

Referring back to the illustrated process 200, a training loop 202 involves repeating a set of operations, including getting the simulation output at 204, calculating the loss (e.g., difference 122 between the simulation output and the output of the reference audio system) at 206, and adjusting the trainable parameters at 208. It is important to note that getting the simulation output at 204 from an input may involve both the trainable parameters 114 and the non-trainable parameters 112 within the context of a closed loop system 116 of fully implicit equations. This is in contrast with earlier methods in the application domain of audio processing, and serves to highlight these advantages. This example simulation may be computed in the time domain.

In the illustrated process 200, the training loop 202 also involves at 206 applying a loss function to the simulation output. This can be, for example, a perceptual loss function that is tuned according to psychoacoustic properties of the human auditory system. In example embodiments, this perceptual loss function is computed in the frequency domain, As an example, a perceptual loss function could measure the frequency bins according to a logarithmic scale (e.g., the Mel scale). In that case, the frequency bins may be spaced in a predetermined pattern that is deemed suitable for psychoacoustic measurements in the frequency domain.

As another example, a perceptual loss function can apply weighting to the frequency bins in the error signal. In this case, the error signal is defined as the difference 122 (FIG. 1) between desired output and target output of the modeling audio system. The weighting can be, for example, according to the Fletcher-Munson curves of perceived loudness for the human auditory system.

Other perceptual loss functions are possible, associated with frequency masking, temporal masking, and so on. In general, the goal is to save computing resources by not matching the reference audio system to the degree of inaudible effects, relative to the average listener.

In the illustrated process 200, the training loop 202 further includes adjusting at 208 the trainable parameters 114 (e.g., changing one or more trainable parameters) according to the output of the loss function 206 in order to minimize the loss function. Furthermore, in some embodiments, it is possible to fix one or more trainable parameters and treat them as non-trainable (i.e., not changing them during training). This can be limited to some of the training procedure 202 or encompass the entire training procedure. Thus, it is possible to save computing resources (e.g., by constructing the modeling audio system in stages).

At 210, a decision is made on whether to continue the training procedure or stop (e.g., by applying one or more stopping conditions). One example is when the loss function is not low enough according to some predetermined threshold, in which case the training continues. Another instance is when there is more training data to use, in which case training also continues, or the like. If training is considered to be completed, process 200 continues on to outputting a model file 126. This model file can include trainable parameters, known dynamics, their combination, and/or the like.

In some embodiments, the model file can later be loaded and executed to instantiate a functioning model of the reference audio system. Alternatively, or in addition, the training process can also output information (e.g., error graphs, quantitative data, time series, and/or the like) that may further aid other processes (e.g., an additional training step when constructing the modeling audio system in stages).

In various embodiments, training is end-to-end and includes both trainable parameters and known system dynamics. This enables capturing information that only appears when considering the behavior of the entire reference audio system in a fully implicit sense (e.g., a closed loop system). This is in contrast with other methods that are based on block-wise processing (i.e., computing each stage (block) independently). Furthermore, the reference audio system may be modeled in continuous time, rather than discrete time. In this example, there is no need to add artificial sample delays in feedback paths for the method to work. In addition, the modeling audio system may be capable of real-time operation (i.e., handling real-time audio input), processing it, and delivering real-time audio output. The real-time operation may include any control inputs (e.g., knobs) that can also be inside the closed loop. Real-time may be relevative to the perception of the musician coupling their instrument to the input of the modeling audio system, as noted in FIG. 1. Therefore, small algorithmic latency (e.g., <20 ms) may be considered acceptable for real-time operation. Moreover, processing through the modeling audio system may occur in the time domain instead of training that combines time domain and frequency domain processing.

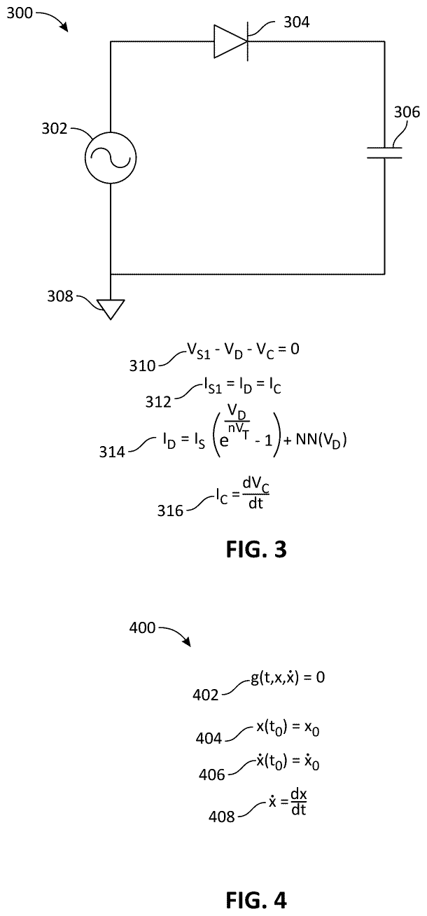

FIG. 3 depicts a circuit schematic 300 representing an example reference audio system 102 in some embodiments. FIG. 3 also depicts example equations that may be used to model the reference audio system 102. In this example, the equations include a neural network which is an instance of the trainable parameters 114. By way of example, consider the electrical circuit that consists of a voltage source 302, a diode 304, and a capacitor 306. The elements are connected in series, as shown in the circuit schematic 300. A reference voltage (ground) 308 completes the circuit.

In order to model this circuit, the voltage source 302 is labeled “Vs1,” the diode 304 is labeled “D,” and the capacitor 306 is labeled “C.” In this example, the capacitor is assumed to be ideal (no parasitics, etc.). Then, a processor (e.g., such as a processor described herein) may derive the circuit equations that describe this system in terms of voltages “V” and currents “I.” The first equation 310 is algebraic, and consists of Kirchhoff's Voltage Law, which tracks the voltages along the loop. The second equation 312 is also algebraic, and consists of Kirchhoff's Current Law, which relates the currents of connected nodes. The third equation 314 is algebraic, and models the current-voltage characteristic (I-V curve) of the diode using the Shockley equation, as well as an additive correction term. In the example, the correction term consists of a Neural Network, herein labeled NN for convenience. The fourth equation 316 is a differential equation, and describes the dynamics of the ideal capacitor.

Taken together in this example, the equations (310, 312, 314, 316) form a system of DAEs (Differential Algebraic Equations), as they consist of both algebraic equations (310, 312, 314) and differential equations (316). Since the DAE system includes a Neural Network (NN), we propose the term “Neural DAE” so as to denote this new class of system. In some embodiments, the equations might be in matrix form, in order to enable convenient and performant linear algebra manipulations (e.g., matrix inversion).

Notice the split between trainable parameters 114 (in this example, the NN part of the third equation 314), and known system dynamics 112 (in this example, the Shockley equation part of the third equation 314, the natural laws of Kirchhoff 310 and 312, and the linear dynamics of the capacitor 316). One aspect of the Neural DAE system is that its equations (310, 312, 314, 316) form a closed loop 116 (i.e., they define a system of fully implicit equations). Therefore, all equations (310, 312, 314, 316) should be solved together, and removing one or more equations results in a different answer. This does not preclude algebraic simplifications (e.g., L{S1} can be replaced by I_C, in accordance with equation 312).

Another aspect of the Neural DAE system is that it may be solved in continuous time, rather than discrete time. In some practical embodiments, the use of Antiderivative Anti-aliasing (ADAA) or oversampling (computing at a higher sample rate) can be used to approximate continuous-time solutions in discrete time. However, Neural DAEs are analogous to Neural ODEs and may be operated in continuous time. In practice, various optimizations are possible, as will be appreciated.

More generally, the trainable parameters 114 are not required to be in the arrangement of a neural network but can be (e.g., parameters trainable in a differentiable programming context), models of interaction between components (e.g., magnetic coupling), models of interaction with external systems (e.g., radiation), and so on. The known dynamics 112 can also vary along the same principles, with the difference that they do not change during the training phase. Also, the corrective additive term in the third equation 314 of this example corresponds to a parallel connection. However, this is only meant to illustrate some embodiments and should not be interpreted as limiting the claimed subject matter to the specific example. For instance, any other connection or combination of connections can be used instead. One example of this would be composition (the output of the first subsystem is input to the second subsystem). In case one or more neural networks are employed as part of the fully implicit loop, they can be, for example, a convolutional neural network (CNN), a recurrent neural network (RNN), a continuous-time echo state network (CTESN), or any other kind of neural network, or any combination thereof.

FIG. 3 depicts a circuit schematic 300 representing an example reference audio system 102 in some embodiments

FIG. 4 depicts an illustration 400 which shows an example formulation for the initial value problem (IVP) for a general system of differential algebraic equations (DAEs) in some embodiments. In this example, equation 402 is the core of the DAE problem formulation. “g” denotes a vector-valued function that relates the vector of state variables “x,” the vector of derivatives of the state variables, as well as the independent variable “t.” Usually “t” is time, but this is not necessary. Note that equation 402 includes both algebraic equations (310, 312, 314) and differential equations (316). Within the context of some embodiments, equation 402 may also include one or more Neural Networks in its equations, as seen in equation 314. In some embodiments, the algorithm may include statistical information with Bayesian Neural DAEs. Data measured from circuits is often costly and difficult to acquire. By adding uncertainty, the method prevents overfitting of scarce data. Further, in some embodiments, the algorithm can include stochastic terms, deriving Stochastic Neural DAEs. For instance, a stochastic term for white noise can be employed to model thermal fluctuations in semiconductors,

Equation 404 in this example shows the initial condition for the state variables. Similarly, equation 406 shows the initial condition for the derivatives of the state variables. Both equations (404, 406) also include an initial value for the independent variable (e.g., initial time). In some embodiments, before solving the DAE problem, it is important that both initial conditions (404, 406) satisfy equation 402. This is called consistent initialization and may be important for the success of the numerical integration procedure.

Finally, equation 408 shows the vector of derivatives of the state variables. It also shows how it can be obtained by differentiating the vector of state variables “x” with respect to the independent variable “t.” An example of a derivative of a state variable can be seen in equation 316.

In order to solve (i.e., evolve forward in time) the DAE IVP, a numerical integration method may be applied. This can be, for example, a backward differentiation formula (BDF), such as the implicit Euler method. Some embodiments described herein use the State-Space formulation for convenience of explanation, however, equivalent alternate formulations can also be employed instead (e.g., Wave Digital Filters (WDF) or port-Hamiltonian systems (PHS)). Note that, in some embodiments, using a different mathematical formulation cannot avoid the need for a fully implicit solving, whenever one is required to fully describe the dynamics of the system.

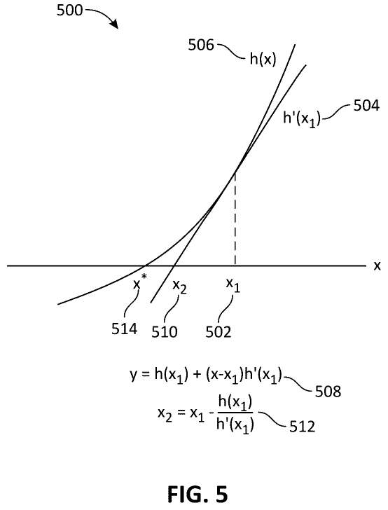

FIG. 5 depicts an illustration 500 that shows an instance of a nonlinear solve in some embodiments. A nonlinear algebraic system is required to be solved at each time step as part of the application of a BDF to the DAE system. This enforces the constraints of equation 402 (i.e., g=0). In this example, the iterative Newton-Raphson solver, which is a common choice within the application domain, is demonstrated. For convenience of explanation, only the 1-dimensional case is shown, with the understanding that the derivatives of equation 408 can be replaced by the Jacobian matrix in the multi-dimensional case or another approach.

Assume the existence of an initial solution estimate 502, corresponding to a state of the state variables (the state in equation 402). There is a slope (i.e., derivative) 504 of function 506 at that estimate 502. Function “h” 506 corresponds to the “g” of equation 402. The tangent 504, given by equation 508, has an x-intercept at point 510, given by equation 512. Thus, in this example, concludes one iteration of the nonlinear root-finding Newton-Raphson procedure. The process repeats with the found point 510 as the new starting estimate. The process concludes by finding the nonlinear root 514 (i.e., the point where h=0 and function 506 intercepts the x-axis). In some embodiments, the root 514 can be considered to be found when function 506 is sufficiently close (e.g., within some specified tolerance) to 0.

The iterative solver is not guaranteed to converge at every time step of the numerical integration. Therefore, in some embodiments, the system may select a smaller time step and try the nonlinear solve of illustration 500 again with the new time step. This is possible because, unlike conventional wisdom within the application domain, the system is in continuous time.

In some embodiments, various performance optimizations are possible. For example, an optimization may be the use of the Damped Newton-Raphson method. As another example, the use of lookup tables (i.e., tabulation) can speed up the computation of functions inside the solver.

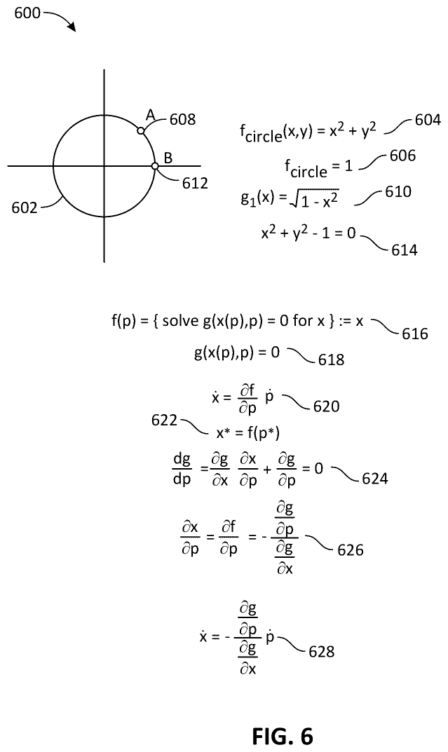

FIG. 6 depicts an illustration 600 that shows a circle 602 as an instance of a definition through an implicit relation in some embodiments. Illustration 600 also contains a possible way to differentiate through the implicit solve of FIG. 5. By way of example, consider the unit circle 602 in the cartesian plane, which is defined via a function 604 of two variables and the implicit relation 606. Although in general “y” cannot be expressed as a function of “x,” around point “A” 608 an explicit expression 610 can be derived for “y” in terms of “x.” No such expression exists around point “B” 612. Note that the explicit expression 610 can be differentiated with respect to its parameter “x.” The implicit function 614 can be equated to zero and differentiated according to the Implicit Function Theorem to get the implicit derivative of “y” with respect to “x.” This works even for the points where no explicit expression exists to be differentiated, provided that the theorem's conditions apply.

Returning now to the matter of Neural DAEs, a way can be defined to change the trainable parameters 114. With traditional neural networks (e.g., neural networks that comprise fully connected layers) this can be achieved via backpropagation of gradients. In Neural DAEs, this would include backpropagation through the nonlinear solves of FIG. 5. An alternate way to achieve this which utilizes Automatic Differentiation is presented herein.

In some embodiments, let f(p) be a root-finding procedure 616 (e.g., the nonlinear root-finding Newton-Raphson procedure defined by way of example in FIG. 5). The root-finding procedure 616 finds the nonlinear root “x*” defined by a fully implicit relation 618 for example, the constraints g=0 of equation 402. In this notation, “p” is a vector of parameters (e.g., the trainable parameters 114). In addition, “x” is a state vector that contains any combination of differential and algebraic variables (e.g., the variables in equations 310, 312, 314, 316). In this example, assume for convenience of explanation that the Newton-Raphson procedure terminates successfully after finding a root “x *.” In this manner, f(p) can be seen as a mapping from the parameters “p” to the root “x *.” Therefore, Automatic Differentiation is an instance of a way to derive the rate of change 620 of “x*” with respect to a change in the parameters “p.” Nominally, it is possible to unroll the operations of the nonlinear solve and directly use Automatic Differentiation on them. However, this is undesirable for various reasons (e.g., the nonlinear root-finding procedure containing a non-constant number of iterations).

An alternate way is to use the Implicit Function Theorem and differentiate the implicit relation 618. Within the context of this explanation, “x” is evaluated at the root “x*” with parameters “p*” at that point 622, and the root notation is dropped for convenience. Equation 620 shows the Jacobian matrix (since “x” and “p” are both vectors in the general case) multiplied by the rate of change of the parameter vector to give the Vector-Jacobian product.

Differentiating the implicit relation 618, the result is equation 624. Note that the implicit relation “g” depends on “x.” Since “x” is a function of “p,” “g” also depends on “p” through “x.” Therefore, the chain rule of differentiation applies. Since the implicit relation equals zero by definition, its derivative must also equal zero. The function “f” can replace its output “x” in equation 624, resulting in equation 626. Combining 626 and 620 results in equation 628, which can be solved as a linear system of equations to get the rate of change of “x.”

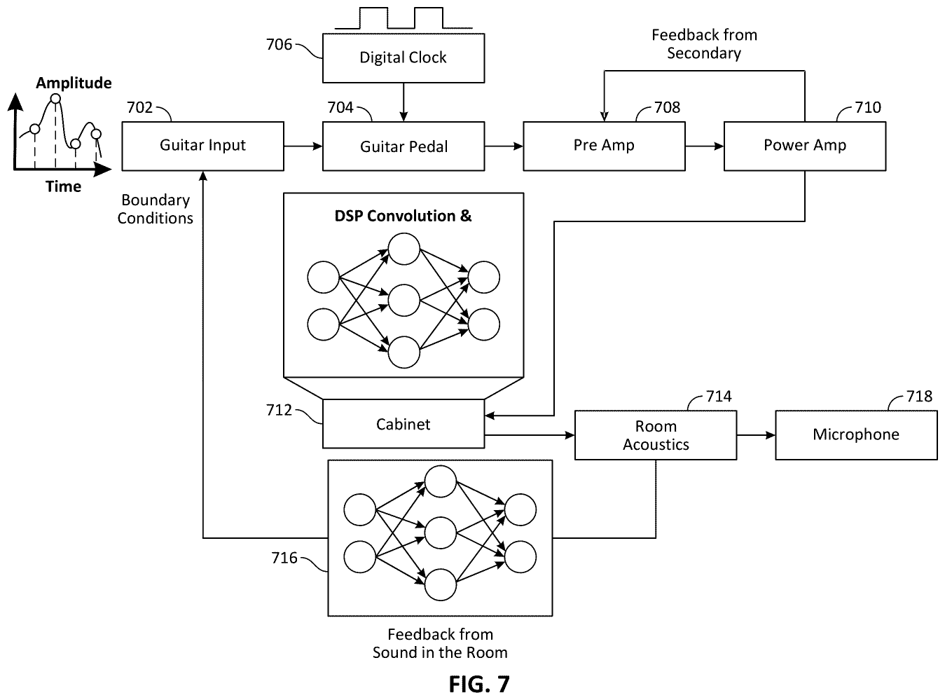

FIG. 7 depicts an illustration 700 showing an example model of a closed loop system in some embodiments. In one embodiment, the system being modeled comprises a typical guitar amplifier audio processing chain. Notably, the model may be processed in continuous time, may include feedback paths, and may need not introduce any artificial sample delays. The audio processing chain starts at the input signal 702, which comes from an instrument (e.g., a guitar) coupled into the input of the audio modeling system. Input to the audio modeling system may be in the form of audio samples, in which case it can be converted into continuous time for use as a forcing function inside the implicit loop. Conversion into continuous time may be done by any suitable process (e.g., linear interpolation, Hermite interpolation, zero-order hold, or the like), In this example, an interpolation process is depicted. Multiple input signals can be in place of input signal 702.

The audio processing chain continues with guitar pedal 704, which can be included in the Neural Differential Algebraic Equations (NDAB) formulation (FIG. 3) of the model, and may feature white-box information, black-box information, or their combination. In this example, the guitar pedal receives an additional input in the form of a digital clock 706. Although the digital clock 706 typically operates above the range of frequencies of human hearing, its effects can sometimes result in audible characteristics in the controlled pedal 704. The clock waveform, as depicted, can be included in the white-box part of the model as a signal in continuous time. Optionally, the transitions of the digital clock 706 may be idealized in the model. In practical embodiments, any combination of series or parallel audio processing units may be used in place of guitar pedal 704. Moreover, if the guitar pedal 704 may be controlled internally via a Low Frequency Oscillator (LFO) signal, the LFO can similarly be explicitly included in the white-box part of the model as a signal in continuous time.

Next in the audio processing chain is the first part of the amplifier, which comprises the preamplifier (preamp) 708, which can similarly be included in the NDAE formulation. User controls of the amplifier, in the form of exposed knobs, may be included in the model either via conditioning (e.g., concatenating the control signal to the input signal), or directly inside the implicit loop as white-box information. In this example, the knobs can be modeled as potentiometers in the white-box part of the model. Moreover, the audio modeling system may include features during deployment that are not in the real amplifier during the training phase, (e.g., the option of additional distortion stages). In addition to (or instead of) a user, the proposed system can be controlled by a different system (e.g., automated controls). For instance, the case where a side chain signal is used to control the system is common in Dynamic Range Compression (DRC).

Further in the audio processing chain in this example is the second part of the amplifier, which comprises the power amplifier (power amp) 710, which can similarly be included in the NDAE formulation. In this example, magnetic effects (e.g., hysteresis) in the core of the output transformer of the power amplifier that may be difficult to model analytically can be modeled by the trainable parameters in the arrangement of a neural network. Alternately, or in addition, in the case when a suitable parametric transformer model is known, its parameters can be trained in a differentiable programming context as trainable parameters 114. Furthermore, the example model includes stabilizing feedback from the secondary of the output transformer back to the preamp, as in the real amplifier being modeled. This feedback can be in the known dynamics 112 of the NDAE model, since it is a known electrical connection.

Further yet in the audio processing chain of this example is the cabinet 712 of the amplifier, which can similarly be included in the NDAE formulation. In this example, the acoustic characteristics of the cabinet are modeled by discrete-time convolution with a known impulse response (IR), which is a white-box Digital Signal Processing (DSP) technique. This demonstrates how discrete-time audio processing can be included in a continuous-time simulation, Convolution only covers the linear aspects of the cabinet characteristics. Optionally, trainable parameters in the arrangement of a neural network can act as a corrector in the audio modeling system for the non-linear aspects of the real cabinet being modeled. Thus, a grey-box model of the cabinet is included in the NDAE.

Further yet in the example audio processing chain is a model of the room acoustics 714 (e.g., reverberation), which can similarly be included in the NDAE formulation. For instance, the model can use a DSP convolution to cover the linear aspects of the room acoustics.

Alternately, it can model the reflections directly with a three-dimensional spatial discretization scheme. Either of those options can be combined with trainable parameters in the arrangement of a neural network that can act as a corrector for the non-linear aspects of the room being modeled.

Part of the signal of the room acoustics 714 may return via a feedback path 716 as “room sound” and resonate the guitar strings or body, changing the guitar input 702. Although this feedback from sound in the room may be difficult to model analytically, it can be explicitly included in the NDAE model in the form of trainable parameters in the arrangement of a neural network. In addition, in the case the amount of propagation delay for the “room sound” is known, it can be included in the white-box part of the NDAE model inside the known dynamics 112.

Further yet in the example audio processing chain is a model of the microphone 718, which picks up the audio output. The microphone 718 can similarly be included in the NDAE formulation. Optionally, more than one outputs 718 may be produced at the same time from the amplifier model (e.g., simulating multiple microphones recording the sound of the amplifier). Spectral properties of the output 718 may be used within the difference function 122 when training the trainable parameters of the model.

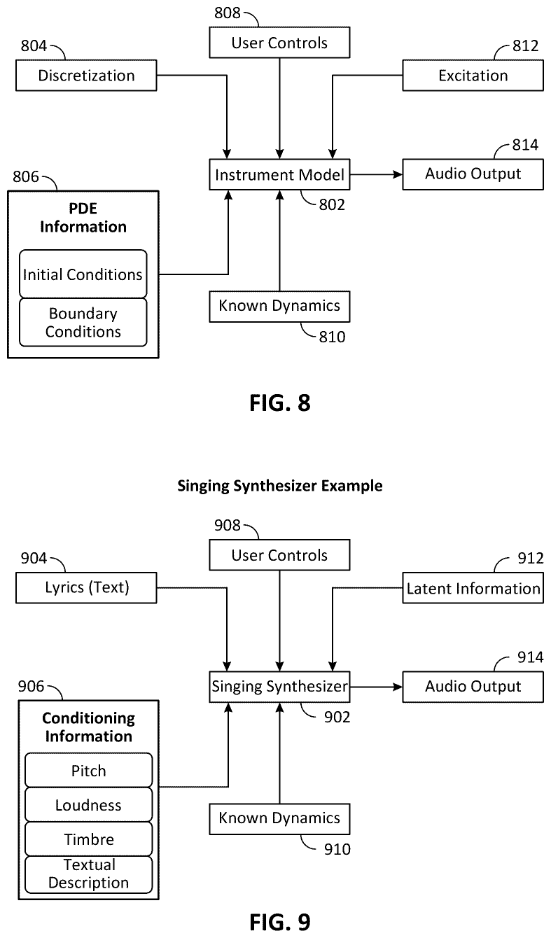

FIG. 8 depicts an illustration 800 which shows an example model of a musical instrument in some embodiments. The example system being modeled comprises a physical musical instrument (e.g., a violin or a trumpet). In this example, the model can be processed in continuous time, may include feedback paths, and need not introduce any artificial sample delays.

In the case of modeling a physical musical instrument, the Neural Differential Algebraic Equations (NDAE) formulation (FIG. 3) of the model can be extended to include Partial Differential Equations (PDEs), resulting in a Neural Partial Differential Algebraic Equations (NPDAE) formulation. In some embodiments, the instrument model 802 is converted to PDEs via an appropriate spatial discretization 804. For instance, a vibrating string of a violin may be modeled as a set of equidistant points that are connected and move with time. In another example, the volume of air inside the tube of a trumpet can be modeled in multiple dimensions. Note that the discretization 804 can be time-varying (e.g., adding and/or removing points dynamically in real-time). For instance, the tube of a trombone that changes length can be modeled with a dynamic grid. The model may feature white-box information, black-box information, or their combination.

In various embodiments, in the PDE case, additional PDE information 806 must also be defined for the system model to be consistent. This PDE information 806 includes boundary conditions (e.g., Dirichlet) on the boundaries of the spatial domain. The derivatives require definitions of boundary conditions as well. In addition, initial conditions must be defined for the time-varying states. In addition to, or in place of, Finite-difference time-domain (FDTD) methods and Finite Difference Schemes (FDS), other methods to model a physical system can be employed instead. More generally, all discrete-time traditional Digital Signal Processing (DSP) techniques can appear in this context. As an example, this can include methods based on Digital Waveguides (DWG). Alternately, the Functional Transformation Method (FTM) may be employed. Parameters of these methods can be trained in a differentiable programming context and/or comprise neural networks.

The instrument model 802 can be responsive to user controls 808, so that it can be played in real-time within the context of a musical performance. These can be, for example, MIDI notes. Parameters of the instrument model can also be changed via user controls 808, in which case they are added to the white-box part 112 of the model. User controls 808 may also include a realistic instrument controller (e.g., a MIDI breath controller for a wind-driven instrument).

Another input to the instrument model 802 can be knowledge 810 about the physics of the musical instrument that acts as known dynamics 112 of the PDAE model. For instance, this can be information about the resonating instrument body, reverberation and other room effects, feedback effects, etc. In addition, these physical parameters can be changed in real-time in order to control the instrument model (e.g., as part of a performance).

Yet another input to the instrument model 802 may be knowledge 812 about the excitation or known noise profiles that can be included in the known dynamics 112 of the PDAE model. For instance, a known noise source can be included in the white-box part of the model in the form of Stochastic Differential Equations (SDEs). These can be combined with PDAEs to create a Stochastic Partial Differential Algebraic Equation (SPDAE) formulation. Similarly, other statistical properties of known parameters can be included in the Neural SPDAE model. The statistical properties may also be learned as trainable parameters 114 within a differentiable programming context. Multiple excitations and/or noise sources can similarly be include in the PDAE model.

The instrument model 802 produces audio output 814 (e.g., the instrument performance). In addition to being run in real-time, the instrument model may also produce multiple instrument performances (e.g., be run in batch mode). Furthermore, more than one outputs 814 may be produced (e.g., at the same time) from the instrument model (e.g., simulating multiple microphones recording the sound of the instrument).

FIG. 9 depicts an illustration 900 that shows an example model that comprises a singing synthesizer in some embodiments. The system being modeled in this example is the human vocal tract. Similarly to the other examples presented herein, the model can be a closed loop system with fully implicit loops. One of the inputs to the singing synthesizer 902 in this example is the lyrics 904 for the singing synthesis. These can be in the form of text, split into tokens, contain semantic information or metadata, and so on.

Another input to the singing synthesizer 902 in this example can be conditioning information 906, including pitch, loudness, timbre, and/or the like. This conditioning information 906 may be used to guide the singing synthesizer to produce output with the desired aural characteristics. This conditioning information 906 can also be time-varying to enable dynamic performances by the user (e.g., a musician). In addition, or alternately, the conditioning information 906 can be in the form of a textual description of the desired aural characteristics of the output that will be produced. For instance, a singing performance can be described as “soulful” in this context.

Another input to the singing synthesizer 902 can be controls 908 that enable the user to control the singing synthesizer. For instance, the user may control the singing synthesizer via MIDI notes to make the singing synthesizer follow a melody line. Alternately, or in addition, the user may change the controls 908 in real-time to change the corresponding aural characteristics of the produced output, within the context of a performance.

Yet another input to the singing synthesizer 902 in this example may be knowledge about the physics of the vocal tract 910 that acts as known dynamics 112 of the DAE model, For instance, this can be information that describes the position of the tongue, the position and size of the lips, the constriction of the throat, and/or the like. In addition, these physical parameters can be changed in real-time in order to control the singing synthesizer (e.g., as part of a performance).

Furthermore, in the case that excitation or noise profiles are known, they can be included in the known dynamics 910. For instance, a known noise source may be included in the white-box part of the model in the form of Stochastic Differential Equations (SDEs). These may be combined with DAEs to create a Stochastic Differential Algebraic Equation (SDAE) formulation. Similarly, other statistical properties of known parameters may be included in the Neural SDAE model.

Still another input to the singing synthesizer 902 may be latent information 912. For instance, this can be a projection via an encoder of the input onto a latent space. The latent space may be projected back via a decoder onto an additional control input to the singing synthesizer.

In this example, both the encoder and the decoder comprise of trainable parameters 114 within a differentiable programming context. The singing synthesizer 902 produces audio output 914, i.e., the vocal performance. In addition to being run in real-time, the singing synthesizer can also produce multiple vocal performances, i.e., be run in batch mode.

In contrast with the guitar amplifier example (FIG. 7), the singing synthesizer may not require real-time audio input. In some embodiments, it may be configured to accept audio input, in which case it becomes a model capable of timbre transfer (e.g., it imparts the desired characteristics dialed in by the user onto an audio input).

The difference function 122 may be based on time-varying spectral characteristics of the model output in the frequency domain. It may also feature evaluation based on perceptual metrics (e.g., how realistic the singing appears to a listener). Although this example describes a singing synthesizer, similar techniques may be applied, for example, to speech synthesis.

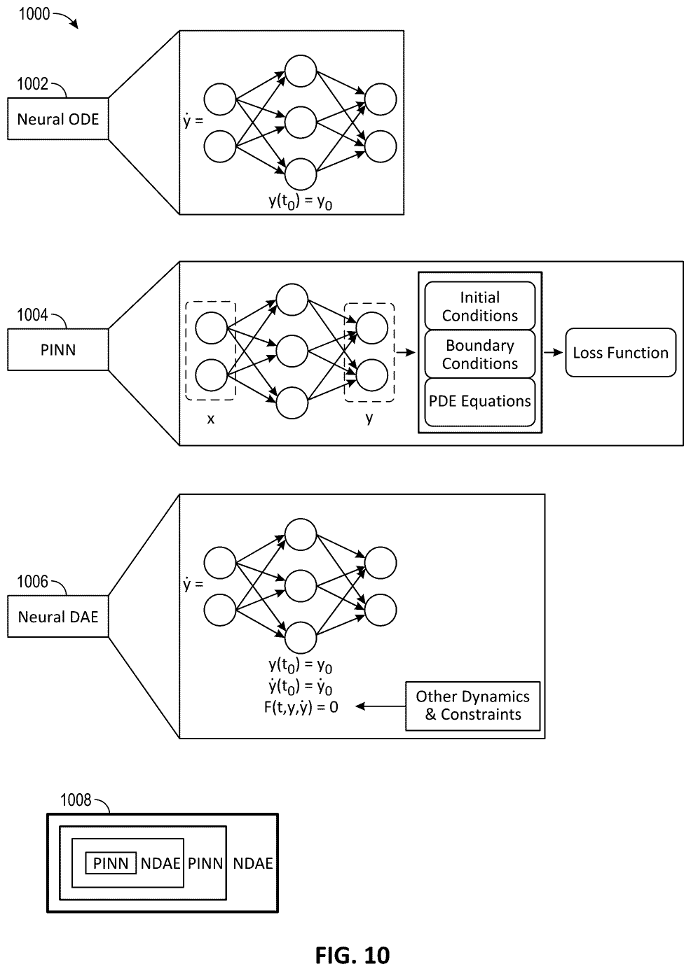

FIG. 10 depicts an illustration 1000 that shows an example model of a closed loop system in some embodiments. The system being modeled features nested operations in the form of subsystems. As illustrated, the Neural Ordinary Differential Equation (NODE) 1002 comprises a neural network inside the solving (e.g., evolving forward in time) of an Ordinary Differential Equation (ODE).

The opposite is having the solution of an ODE inside a neural network. In the multidimensional case, a Partial Differential Equation (PDE) formulation may be used, creating a Physics-Informed Neural Network (PINN) 1004. The physically-derived terms (e.g., Initial Conditions of the PDE, Boundary Conditions of the PDE, residual of the PDE System, difference from observed samples, and/or the like) can all participate in the loss function when training the neural network,

Adding nonlinear constraints extends the NODE to an NDAE 1006. Thus, it is possible to combine the previously described subsystems with a PINN inside an NDAE inside a PINN inside an NDAE 1008. This illustrates the composability of some embodiments. For instance, it can allow for arbitrarily nested operations. In some embodiments, all operations used may be differentiable, therefore the model can be differentiated end-to-end using Automatic Differentiation techniques. This aids the process of training the trainable parameters.

It will be appreciated that any number of models of the same instrument may be created. Each model may include a virtualization of the instrument with different settings, different acoustic environments, and the like. Further, there may be any number of models of different instruments, voices, audio signals (musical and/or nonmusical) combination of instruments, combination of audio signals, and the like. In some embodiments, an online platform (e.g., controlled by a web server or other digital device) may enable different users remote from each other to identify desired models (e.g., of the desired system and the desired system parameters) and download the desired models for installation or use in their systems. In some embodiments, the platform may enable the user to identify and pay for (e.g., a one-time or recurring licensing fee) for any number of models. In various embodiments, the platform may enable any number of users to upload input signals to be created into reference signals and to control trainable parameters such that they may assist in creating a new model for their use and/or the user of others.

In some embodiments, an example process comprises training the trainable parameters of a closed loop system. The result of this training is a digital audio system, capable of emulating the characteristic behavior of a reference audio system. Training the trainable parameters consists of repeatedly performing predicting, evaluating and updating operations. The prediction operation involves obtaining an output from the closed loop system, based upon an input, where the output emulates some characteristics of the expected output of the reference audio system. Herein, the prediction involves the entire closed loop system in an end-to-end manner. Therefore, the prediction is computed in continuous time. The evaluation operation comprises applying a loss function, where the loss function measures the difference between the output of the closed loop system and the output of the reference audio system. This loss function can be, for example, a perceptual loss function applied in the frequency domain. The update operation comprises modifying the trainable parameters, according to the output of the loss function. For instance, the update operation can change one or more trainable parameters with the goal of minimizing the loss function. The process further comprises outputting a model file that can be loaded, after training has finished, to create a virtualization of a reference audio system.

In various embodiments, an example process comprises training one or more trainable parameters that, alongside one or more relations of known dynamics, create a virtualization that models a reference audio system. In particular, training the trainable parameters enables the combination of trainable and known dynamics to model a closed loop system that emulates some characteristics of the expected output of the reference audio system. Thus, the known dynamics contribute to the modeling system as non-trainable parameters. In addition, training can be carried out using a perceptual loss function defined in the frequency domain. Moreover, the process may comprise outputting a model file which contains both trainable and non-trainable parameters and can be loaded to generate a virtualization of the reference audio system. Optionally, some or all trainable parameters in the model file can be quantized in order to save storage space.

Further, in some embodiments, an example process may comprise training the closed loop system end-to-end, such that the trainable parameters and known dynamics contribute simultaneously to the virtualization output that is compared to the output of the reference audio system. In contrast, part of the trainable parameters may be frozen for part or all of the training process, such that they are not altered during that specific training process. In that case, the frozen trainable parameters behave as known dynamics for the duration that they are frozen.

Further, in various embodiments, an example closed loop system can be defined in continuous time. Moreover, the closed loop system can include feedback and/or cross-feed paths for one or more signals without the addition of artificial sample delays. Similarly, aspects of the reference audio system may be modeled as conceptual blocks, arranged in series and/or in parallel and/or in various combinations thereof, without sample delays.

Processing through the modeling audio system may occur in the time domain. In contrast, the training process can combine time domain and frequency domain processing. In addition, the modeling audio system can operate in real-time, or perceptually close to real-time. Furthermore, the real-time operation of the modeling audio system can contain controls, including user controls.

According to a further aspect, training the trainable parameters may comprise training a convolutional neural network. Therefore, by using a convolutional neural network, significant computational time and memory savings can be obtained.

According to a further aspect, training the trainable parameters may comprise training a recurrent neural network. Thus, by using feedback connection within the neural network, the recurrent neural network can have a memory effect. Therefore, the number of systems that can be modeled increases.

According to yet further aspects, training the trainable parameters may comprise training the parameters of a digital signal processing (DSP) operation (e.g., discrete-time convolution, low-pass filter, high-pass filter and/or band-pass filter). Thus, traditional audio processing in discrete time can be incorporated into the capabilities of the modeling audio system. Therefore, significant savings in computational resources can be realized.

Training the trainable parameters may comprise training the parameters of an operation defined in continuous time. Thus, simulations of physical systems, including circuits, in continuous time can be incorporated into the capabilities of the modeling audio system. Therefore, significant savings in computational time and memory can be realized.

In some embodiments, applying a perceptual loss function to the closed loop system may comprise implementing frequency-dependent loudness thresholds, such that any differences under the threshold do not contribute to the loss function. Similarly, the loudness thresholds can account for frequency masking effects, such that a frequency component in the range where it is masked does not contribute to the loss function. In any case, time and/or computational resources can be saved by disregarding differences below the threshold(s).

According to yet further aspects, training the trainable parameters may be based on measurements of the reference audio system being modeled, including internal measurements of the reference audio system. Hence, signals of the modeling audio system can be made to match the corresponding signals of the reference audio system.

Training the trainable parameters may be based on measurements of the reference audio system excited by exponential sine sweeps (ESS) or noise. Therefore, the training procedure can be made more reproducible.

The process may comprise outputting a difference signal (e.g., loss signal). The difference signal may be computed by exciting the reference audio system and the modeling audio system with one or more input signals, receiving one or more output signals from the reference audio system and the corresponding output signals from the modeling audio system, and computing therefrom in the time domain, the difference signal. In addition or alternately, computing a difference signal can happen in the frequency domain, after the reference audio system outputs and the corresponding modeling audio system outputs have been converted to the frequency domain. This may be achieved by any suitable transformation (e.g., a Fourier transformation or a Constant Q transformation).

According to further aspects, various combinations of weighting and/or thresholding can be applied to the computation of the difference signal. By basing the computation of the difference signal on psychoacoustic phenomena, including the frequency response(s) of human haring, it is possible to save time and/or computational resources.

In some embodiments, training the trainable parameters may comprise learning the derivatives of a closed loop dynamic system. By computing the difference signal based on the time domain output(s) of the reference audio system and the modeling audio system, rather than the derivatives, a more accurate value for the derivatives can be recovered via training. Similarly, a collocation mixture method may be employed, wherein in a first training phase, the derivatives of the reference audio system and the modeling audio system contribute to the difference signal being computed, and in a second training phase the time domain output(s) of the reference audio system and the modeling audio system contribute to the difference signal.

In various embodiments, a nonlinear root-finding procedure can be employed to enforce the algebraic constraints of a fully implicit closed loop dynamic system. This may be achieved by any suitable root-finding procedure (e.g., the iterative Newton-Raphson procedure for finding nonlinear roots).

According to yet further aspects, the iterative solver can select a smaller time step in continuous time and repeat the nonlinear solve with the new time step. Therefore, the iterative solver can more easily find the roots by operating in continuous time.

In some embodiments, a projection method can be employed to enforce the algebraic constraints of a fully implicit closed loop dynamic system. Thus, the evolving solution in the time domain can be projected to a manifold where the algebraic constraints are maintained.

In some embodiments, all of the operations may be differentiable. Therefore, derivatives with respect to parameters and/or inputs may be calculated. In a similar manner, differentiation can happen through the nonlinear root-finding procedure, allowing it to contribute to the end-to-end training of the trainable parameters.

According to a yet further aspects, the evaluation operation may comprise applying a perceptual loss function as part of computing the difference signal from the time domain and/or frequency domain outputs. When the perceptual loss function is computed in the frequency domain, its input signal is converted and stored into frequency bands, whereupon each band may contain a range of frequencies. The perceptual loss function may also include thresholding and/or masking operations, in accordance with the limits of human hearing. Hence, significant savings in time and/or computational resources can be realized. The computed difference signal may also comprise a weighted mixture of difference signals (e.g., a difference based on the outputs and a difference based on the derivatives of the closed loop dynamic system). Training the trainable parameters comprises changing at least one parameter responsive to the final difference signal(s) (e.g., error).

The process for creating and using a digital audio system may further comprise loading the model file containing both trainable parameters and known dynamics into a model audio system to define a virtualization of the reference audio system. The process further comprises using the virtualization to output one or more signals, including audio signals, that feature at least one of the characteristics of the output(s) of the reference audio system.

Hence, in some embodiments, emulation of the reference audio system by the closed loop dynamic system containing both trainable parameters and known dynamics may be achieved.

Further, outputting the audio signal(s) may be performed upon coupling a musical instrument based on the input from the musical instrument to the modeling audio system. Thus, upon coupling a musical instrument into the closed loop of the modeling audio system, a user can perform using the virtualization in place of the reference audio system, such that the output(s) of the modeling audio system emulate at least one of the characteristics of the output(s) of the reference audio system. In addition, outputting the audio signal(s) may be performed without any audio input to the modeling audio system or with control inputs only, as in the case of generating human speech by emulating the vocal tract.

According to yet further aspects, a process for creating and using digital audio systems is provided. The process comprises training the trainable parameters within a closed loop system that digitally models a reference audio system. Training happens end-to-end and may include known dynamics in the form of non-trainable parameters.

In various embodiments, training the trainable parameters may be carried out by repeatedly performing prediction, evaluation, and correction operations. The prediction operation may comprise predicting by the closed loop system one or more outputs in an end-to-end manner based on one or more inputs, including control inputs, where the output(s) share at least one of the characteristics of the corresponding output(s) of the reference audio system. This prediction is achieved in the time domain. The correction operation updates one or more trainable parameters.

According to yet further aspects, a data processing system comprising a processor configured to perform one or more of the process(es) above, is disclosed. The processor may consist of any form of conventional computer processor, a combination of homogeneous or heterogeneous processors that may communicate, specialized hardware for audio processing applications, and/or processing hardware accessed via a computer network.

According to yet further aspects discussed herein, a hardware system is provided. The hardware system includes an analog to digital converter, a digital to analog converter, and processing circuitry that couples to the analog to digital converter and the digital to analog converter. The processing circuitry includes a processor coupled to memory where the processor executes instructions that train one or more trainable parameter(s) in a manner analogous to that described above. Specifically, the processor executes instructions that train one or more trainable parameter(s) within a closed loop system that digitally models a reference audio system by repeatedly performing instructions. Such instructions are performed to predict by the closed loop system, including both trainable and non-trainable parameters, one or more model output(s) based upon one or more input(s), where the output(s) approximate the corresponding expected output(s) of the reference audio system, and the prediction is carried out in the time domain. Further, said instructions are performed to apply a perceptual loss function to the closed loop system, where the perceptual loss function is applied in the frequency domain. Further, the loss function may be implemented to receive a target signal and sort the received target signal into frequency bands, whereupon each band may contain a range of frequencies. Further, the loss function may also be implemented to apply thresholding and/or masking operations to the frequency bands, subject to the limits of human hearing. Further, the instructions are performed to change at least one trainable parameter responsive to the final error output of the perceptual loss function. Further, the processor executes instructions that generate a model file, which contains both trainable and non-trainable parameters. Moreover, the processor loads the virtualization into a model audio system. Thus, a virtualization of the reference audio system is defined. As such, upon coupling a musical instrument to the hardware system, a user can perform using the virtualization in place of the reference audio system such that the output of the model audio system includes at least one characteristic of the reference audio system.

The wording process as used herein may be understood as a method having method steps as described with regard to the above processes.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of some embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, structures, and internal elements may be described as a single instance. Structures, internal elements, and functionality presented as separate components in example configurations may be implemented as a combined structure or component. Similarly, structures, internal elements, and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description of illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving an input signal from an audio system to be modeled to create a reference signal of the audio system;
receiving trainable and system parameters, the system parameters characterizing unchanging aspects that define a sound of the audio system, the trainable parameters including measurements of at least one component of the audio system to be modeled;
modeling, using a closed loop process, the audio system to create a model of the audio system, the modeling comprising:
simulating an output of the audio system to generate a simulation signal using a neural network configured with the trainable and system parameters;
comparing the simulation signal to the reference signal; and
adjusting weights of the trainable parameters of the neural network to compensate for a difference between the simulation signal and the reference signal;
determining whether a stopping condition is satisfied, the stopping condition being based on the modeling, until the stopping condition is satisfied:
modeling, using the closed loop process, the modeling comprising:
simulating a new output of the audio system to generate a new simulation signal using the neural network including the previously adjusted weights;
comparing the new simulation signal to the reference signal; and
readjusting weights of the trainable parameters of the neural network to compensate for a difference between the new simulation signal and the reference signal; and
outputting the model of the audio system, the model including changes to the trainable parameters derived from the neural network, the model being capable of receiving an input signal and outputting a modeled signal of the audio signal in real time.

2. The non-transitory computer-readable medium of claim 1, wherein the reference signal of the audio system is generated by denoising the input signal from the audio system.

3. The non-transitory computer-readable medium of claim 1, wherein the closed loop process is in continuous time.

4. The non-transitory computer-readable medium of claim 3, wherein the closed loop process does not have sampling delays.

5. The non-transitory computer-readable medium of claim 1, wherein the stopping condition is satisfied when a loss value generated by a loss function applied to the comparison of the new simulation signal to the reference signal is below a threshold value.

6. The non-transitory computer-readable medium of claim 1, wherein the stopping condition is satisfied when modeling occurs a particular number of times.

7. The non-transitory computer-readable medium of claim 6, wherein at least one of the weights of the trainable parameters of the network networks adjusts at least a part of a spectral energy.

8. The non-transitory computer-readable medium of claim 1, wherein the model includes at least one of a sample rate, channel count, or timing for controls.

9. The non-transitory computer-readable medium of claim 1, wherein the audio system is a guitar amplifier.

10. The non-transitory computer-readable medium of claim 1, wherein the audio system is a voice.

11. The non-transitory computer-readable medium of claim 1, wherein simulating the new output of the audio system comprises representing a plurality of the trainable parameters by a plurality of differential algebraic equations (DAEs) in the closed loop process and solving the plurality of differential algebraic equations together in continuous, not discrete, time.

12. The non-transitory computer-readable medium of claim 11, wherein solving the plurality of differential algebraic equations together comprises approximating one or more solutions of the plurality of differential algebraic equations.

13. A method comprising:
receiving an input signal from an audio system to be modeled to create a reference signal of the audio system;
receiving trainable and system parameters, the system parameters characterizing unchanging aspects that define a sound of the audio system, the trainable parameters including measurements of at least one component of the audio system to be modeled;
modeling, using a closed loop process, the audio system to create a model of the audio system, the modeling comprising:
simulating an output of the audio system to generate a simulation signal using a neural network configured with the trainable and system parameters;
comparing the simulation signal to the reference signal; and
adjusting weights of the trainable parameters of the neural network to compensate for a difference between the simulation signal and the reference signal;
determining whether a stopping condition is satisfied, the stopping condition being based on the modeling, until the stopping condition is satisfied:
modeling, using the closed loop process, the modeling comprising:
simulating a new output of the audio system to generate a new simulation signal using the neural network including the previously adjusted weights;
comparing the new simulation signal to the reference signal; and
readjusting weights of the trainable parameters of the neural network to compensate for a difference between the new simulation signal and the reference signal; and
outputting the model of the audio system, the model including changes to the trainable parameters derived from the neural network, the model being capable of receiving an input signal and outputting a modeled signal of the audio signal in real time.

14. The method of claim 13, wherein the reference signal of the audio system is generated by denoising the input signal from the audio system.

15. The method of claim 13, wherein the closed loop process is in continuous time.

16. The method of claim 14, wherein the closed loop process does not have sampling delays.

17. The method of claim 13, wherein the stopping condition is satisfied when a loss value generated by a loss function applied to the comparison of the new simulation signal to the reference signal is below a threshold value.

18. The method of claim 13, wherein the stopping condition is satisfied when modeling occurs a particular number of times.

19. The method of claim 18, wherein at least one of the weights of the trainable parameters of the network networks adjusts at least a part of a spectral energy.

20. The method of claim 13, wherein the model includes at least one of a sample rate, channel count, or timing for controls.

21. The method of claim 13, wherein the audio system is a guitar amplifier.

22. The method of claim 13, wherein simulating the new output of the audio system comprises representing a plurality of the trainable parameters by a plurality of differential algebraic equations (DAEs) in the closed loop process and solving the plurality of differential algebraic equations together in continuous, not discrete, time.

23. The method of claim 22, wherein solving the plurality of differential algebraic equations together comprises approximating one or more solutions of the plurality of differential algebraic equations.

24. A system comprising at least one processor and memory containing executable instructions, the executable instructions being executable by the at least one processor to:
receive an input signal from an audio system to be modeled to create a reference signal of the audio system;
receive trainable and system parameters, the system parameters characterizing unchanging aspects that define a sound of the audio system, the trainable parameters including measurements of at least one component of the audio system to be modeled;
model, using a closed loop process, the audio system to create a model of the audio system, the modeling comprising the at least one processor configured to:
simulate an output of the audio system to generate a simulation signal using a neural network configured with the trainable and system parameters;
compare the simulation signal to the reference signal; and
adjust weights of the trainable parameters of the neural network to compensate for a difference between the simulation signal and the reference signal;
determine whether a stopping condition is satisfied, the stopping condition being based on the modeling, until the stopping condition is satisfied:
model, using the closed loop process, the modeling comprising the at least one processor configured to:
simulate a new output of the audio system to generate a new simulation signal using the neural network including the previously adjusted weights;
compare the new simulation signal to the reference signal; and
readjust weights of the trainable parameters of the neural network to compensate for a difference between the new simulation signal and the reference signal;
output the model of the audio system, the model including changes to the trainable parameters derived from the neural network, the model being capable of receiving an input signal and outputting a modeled signal of the audio signal in real time.
